(19) United States
(12) Patent Application Publication
(10) Pub. No.: US 2011/0050319 A1
(43) Pub. Date: Mar. 3, 2011

(54) Multiplier, Mixer, Modulator, Receiver and Transmitter

(75) Inventor: Alan Chi Wai Wong, Oxfordshire (GB)

(73) Assignee: Toumaz Technology Limited, Oxfordshire (GB)

(21) Appl. No.: 12/676,150

(22) PCT Filed: Jul. 29, 2008
(86) PCT No.: PCT/GB08/50637

§ 371 Date: Aug. 26, 2010

(30) Foreign Application Priority Data
Sep. 3, 2007 (GB) 0717042.6

(51) Int. Cl. G06G 7/16

(52) U.S. Cl. 327/356

(57) ABSTRACT

A multiplier is provided, for example, for use as a mixer in a modulator of a radio frequency transmitter. The multiplier multiplies a first alternating signal of constant amplitude by a second signal, for example, in the form of a carrier wave from a local oscillator. The multiplier comprises a transconductance stage for converting the first signal to a differential output current and a current switching stage for switching the differential output current in accordance with the second signal. The transconductance stage comprises a plurality of offset pairs of transistors, whose inputs and outputs are connected in parallel. The switching stage comprises cross-coupled pairs of transistors which, together with the transconductance stage, form a Gilbert cell. The relative gains of the transistors of each offset pair are such that a minimum in the third harmonic distortion characteristic of the multiplier occurs substantially at the amplitude of the first signal.

The present invention relates to a multiplier for multiplying a first signal by a second signal. The present invention also relates to a mixer for a receiver including such a multiplier and to a receiver including such a mixer. The present invention further relates to a modulator including such a multiplier and to a transmitter including such a modulator. The present invention also relates to methods of designing and making such a multiplier.

IQ (in-phase/quadrature) modulation is a method commonly used to carry data on a carrier signal. It involves two orthogonal (I and Q) baseband signals modulating respective mixers driven by quadrature Local Oscillator (RF carrier) signals. The outputs of the modulators are summed to provide a single-sideband modulated radio frequency (RF) signal. Constant-envelope modulation schemes are those in which the baseband IQ signals are purely phase or frequency modulated (e.g. FSK, GMSK etc.), without any amplitude modulation. As such, the analogue baseband IQ signals that are input to the IQ modulator are of constant amplitude.

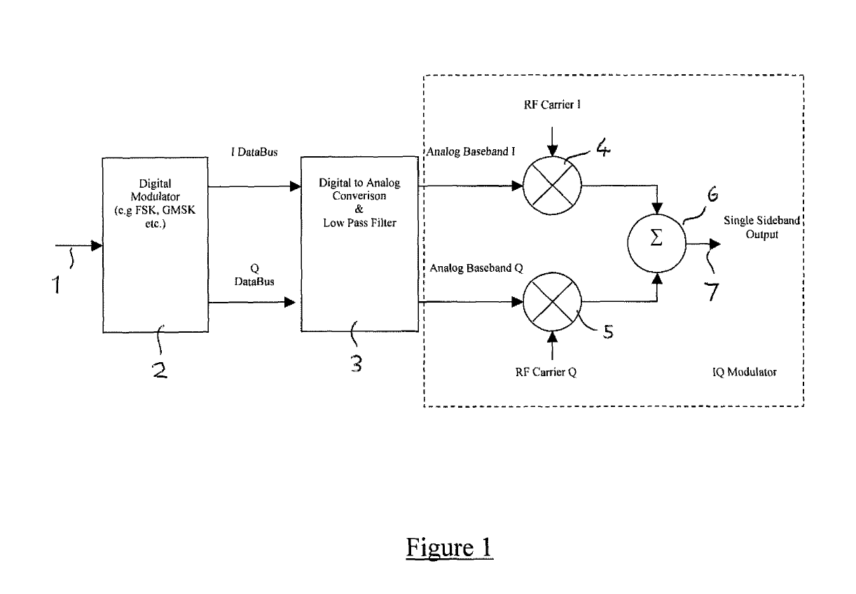

A typical IQ modulation architecture is illustrated in FIG. 1 of the accompanying drawings. A digital information signal is received at an input 1 of a digital modulator 2. The digital modulator generates the two orthogonal, digital baseband signals at outputs I DataBus and Q DataBus. The baseband signals are converted to respective analog baseband signals by a digital-to-analog converter (DAC) and low pass filter 3, and are then mixed at respective mixers 4 and 5 with I and Q carrier signals (i.e. 90 degree phase shifted signals at the same carrier frequency). The outputs of the mixers are summed in a summer 6 to provide a single sideband output signal at an output 7. Commercial IQ modulators routinely utilise a Gilbert Cell topology for the mixing cells, for example as disclosed in B. Gilbert, “A Precise Four-Quadrant Multiplier with Subnanosecond Response,” IEEE Journal of Solid-State Circuits, pp 365-73, December 1968.

In practice, known IQ modulators suffer from imperfections, which result in the inclusion of unwanted components in the output spectra. In particular, the following unwanted components can arise:

(i) carrier (F_{CARRIER} or F_{RF}) caused by DC offsets;

(ii) “Image” (F_{LSB} or F_{IMAGE}) caused by IQ gain and phase imbalances; and

(iii) third-harmonic-distortion (F_{3LSB}) caused by modulator input distortion.

The third harmonic distortion component is measured in decibels relative to the wanted component (F_{USB}) and is spaced below the carrier frequency F_{RF} by three times the spacing F_{bb} between the carrier frequency F_{RF} and the wanted component F_{USB}.

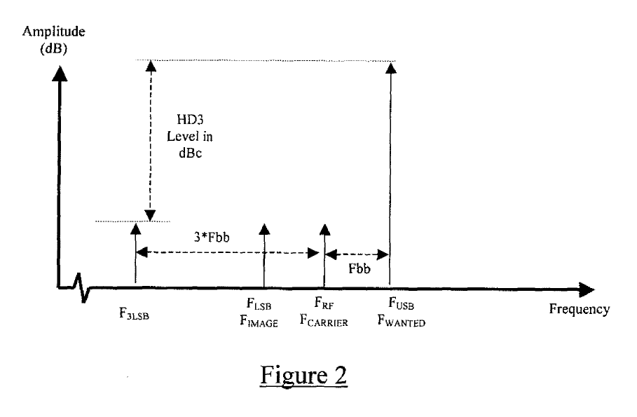

FIG. 2 illustrates these components, as well as showing the “wanted” sideband component at F_{USB} (F_{WANTED}). As well as impacting on modulation accuracy (and hence link reliability), these unwanted components can cause problems to other users operating in the same frequency spectrum, as well as potentially resulting in a failure to comply with regulatory standards for spurious transmit emissions.

Considering further the third-harmonic distortion (known as “HD3”), this may be reduced by linearising the transconductance gain within the Gilbert cell of the conventional modulation architecture. Several linearization techniques exist, the most common of which in CMOS IC designs are resistive degeneration and increasing gate overdrive voltage. Other linearization techniques such as “feed-forward” and “pre-distortion” can achieve linearity improvements but at the cost of additional power consumption.

According to a first aspect of the invention, there is provided a multiplier for multiplying a first alternating signal of substantially constant amplitude by a second signal, comprising a transconductance stage for converting the first signal to a differential current and a current steering stage for steering the differential current in accordance with the second signal, the transconductance stage comprising a plurality of offset pairs of transistors with the inputs of the offset pairs being connected in parallel and the outputs of the offset pairs being connected in parallel, the relative gains of the transistors of each pair being such that a minimum in third harmonic distortion occurs substantially at the amplitude of the first signal.

The term “offset pair” as used herein refers to a differential stage comprising first and second limbs, each of which comprises one transistor or a plurality of transistors connected in parallel. The common terminals of the transistors are connected together and receive a substantially constant “tail” current, where the common terminals comprise emitters of bipolar junction transistors or sources of field effect transistors. The first and second limbs provide different gains.

The transistors may be metal oxide silicon transistors, such as complementary metal oxide silicon transistors.

The first signal may be a sine wave of substantially constant peak-to-peak amplitude.

The second signal may be an alternating signal, such as a sine wave. The second signal may be of substantially constant amplitude.

The offset pairs may be substantially identical to each other.

The offset pairs may have identical tail currents.

Each of the offset pairs may comprise a first transistor and a compound transistor arranged as a differential pair, the compound transistor comprising m second transistors connected in parallel with each other, where m is selected to provide the minimum in third harmonic distortion and each of the second transistors is substantially identical to the first transistor.

The plurality of offset pairs may comprise two offset pairs with the output of the transistor of higher gain of each of the pairs being connected to the output of the transistor of lower gain of the other of the pairs.

The current steering stage may comprise a current switching stage. The current switching stage may comprise two pairs of cross-coupled transistors.

At least one of the first and second signals may be a radio frequency signal.

According to a second aspect of the invention, there is provided a mixer for a receiver, comprising a multiplier according to the first aspect of the invention.

According to a third aspect of the invention, there is provided a receiver comprising a mixer according to the second aspect of the invention.

According to a fourth aspect of the invention, there is provided a modulator comprising a first multiplier according to the first aspect of the invention.

The first signal may be an information-carrying signal and the second signal maybe a carrier wave. The first signal may be a frequency and/or phase modulated signal.

The modulator may comprise a second multiplier according to the first aspect of the invention cooperating with the first multiplier to form a single sideband suppressed carrier modulator.

According to a fifth aspect of the invention, there is provided a transmitter comprising a modulator according to the fourth aspect of the invention.

According to a sixth aspect of the invention, there is provided a method of designing a multiplier according to the first aspect of the invention, comprising specifying the constant amplitude, simulating operation of the multiplier for a plurality of values of the relative gains to determine the harmonic distortion, and selecting a relative gain value corresponding to a third harmonic distortion value at or adjacent a minimum in the third harmonic distortion characteristic.

According to a seventh aspect of the invention, there is provided a method of making a multiplier, comprising performing a method according to the sixth aspect of the invention to provide a design for the multiplier and manufacturing the multiplier in accordance with the design.

It is thus possible to provide a technique which allows linearization of a transconductance stage, such as a CMOS transconductance stage, without requiring any additional power consumption. In particular, third harmonic distortion may be greatly reduced. Although a null occurs in the third harmonic distortion characteristic so that theoretically the third harmonic distortion component may be eliminated, in practice the attenuation at the null is finite. However, very high values of attenuation may be achieved so that the third harmonic distortion component may be greatly attenuated to the point where, in many applications, it is effectively no longer significant or even present.

These techniques require a first alternating signal of substantially constant and known amplitude. It is possible to use these techniques for any multiplier where this is the case and an example of such an application is in a wireless transmitter operating a constant envelope modulation scheme. In such an application, output modulated third harmonic distortion induced RF spurious levels may be nulled or attenuated to such a degree that they are no longer an issue.

It is also possible to use these techniques in a mixer of a radio frequency receiver, provided the input signal can be maintained at a substantially constant and known amplitude. For example, this may be achieved by applying automatic gain control techniques ahead of a mixer of the receiver incorporating such a multiplier.

The invention will be further described, by way of example, with reference to the accompanying drawings, in which:

FIG. 1 is a block schematic diagram of an IQ modulator of known type;

FIG. 2 is a graph of amplitude in decibels (dB) against frequency of wanted and unwanted output components produced by the modulator of FIG. 1;

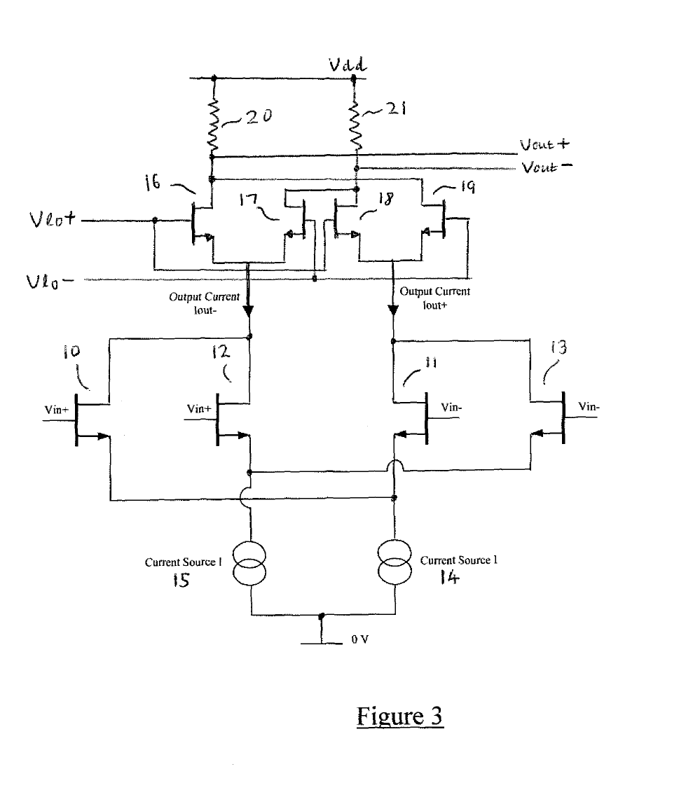

FIG. 3 is a circuit diagram of a multiplier which maybe used in a modulator or transmitter and which constitutes an embodiment of the invention;

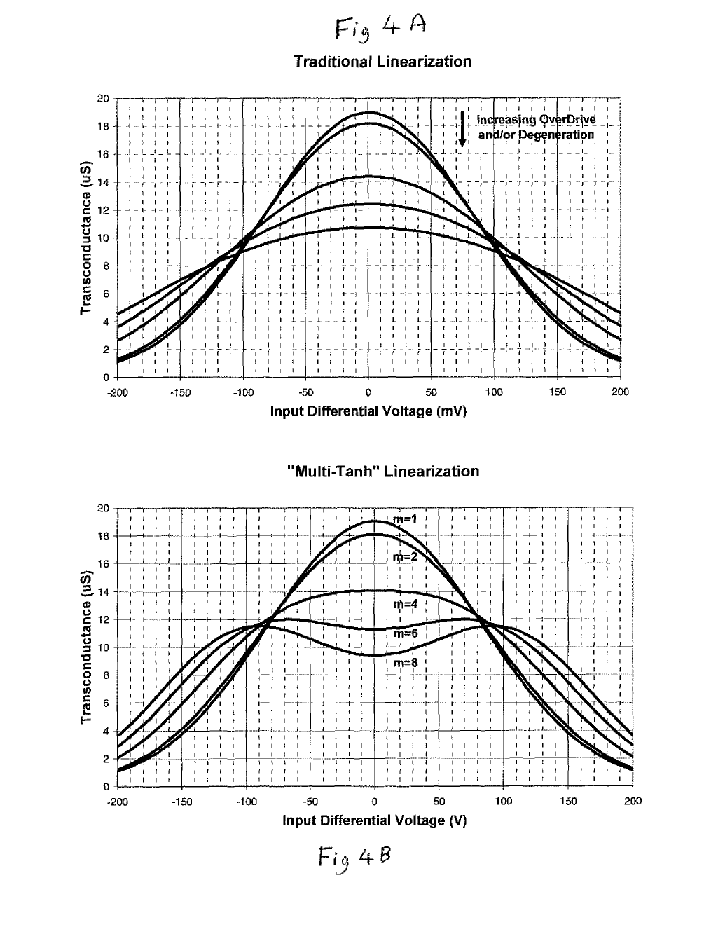

FIGS. 4A and 4B illustrate the transfer characteristics of known linersation techniques and the present technique as transconductance in microsiemens against differential input voltage in millivolts; and

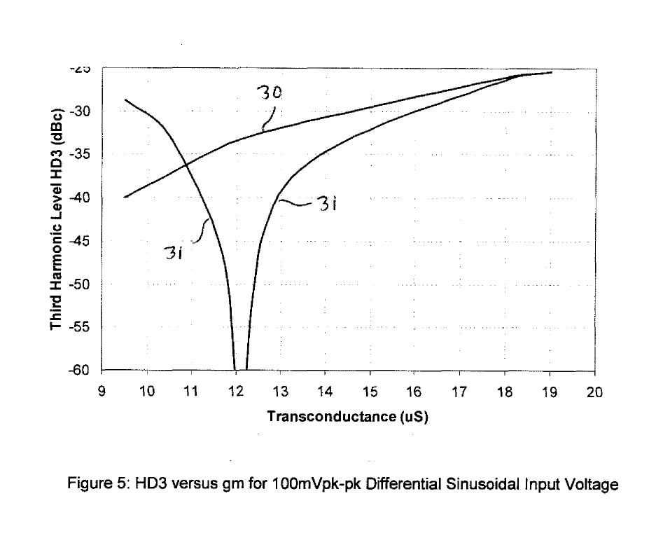

FIG. 5 is a graph of third harmonic distortion in dBc against transconductance in microsiemens showing the third harmonic distortion characteristic of a known linearisation technique and of the present technique.

B. Gilbert, “The Multi-tanh Principle: A Tutorial Overview,” IEEE Journal of Solid-State Circuits, 33(1), pp. 2-17, January 1998, describes a concept known as the multi-tanh principle which achieves linearisation of the overall transconductance function of a transconductance cell by combining individually non-linear transconductance functions. More particularly, the multi-tanh transconductance principle relies upon the series or parallel connection of differential pairs of bipolar transistors with the inputs and outputs being connected in parallel and with the base voltages of the individual cells being offset by some amount. This results in the individual transconductances gₘ being split along the input voltage axis allowing the amplifier to handle greater voltage swings at its input.

Multi-tanh amplifiers have in the past been proposed for use as mixers and tuneable filters in radio frequency receivers, where input voltage levels can vary significantly due to factors such as distance between transmitter and receiver and noise and interference. However, multi-tanh amplifiers have not been proposed for use in transmitters where the level of the input voltage is substantially constant.

It is proposed here to adapt the multi-tanh principle for use with CMOS technology, and to apply it to the specific application of third-order distortion reduction, for example, in IQ modulators with constant envelope transmissions.

FIG. 3 illustrates schematically the application of the multi-tanh principle to CMOS technologies in simple “doublet” architecture. The multiplier shown in FIG. 3 comprises a transconductance stage whose output is connected to a current switching stage. The transconductance stage comprises a first offset pair of transistors 10 and 11 and a second offset pair of transistors 12 and 13. The sources of the transistors 10 and 11 are connected to a constant current source 14 whereas the sources of the transistors 12 and 13 are connected to a constant current source 15. The constant current sources 14 and 15 provide constant tail currents I for the offset pairs and are connected to a common supply line OV.

The transistor 10 comprises a single transistor having a channel of length L and of width W. The transistor 11 comprises a compound transistor in the form of m transistors, which are connected in parallel and each of which is substantially identical to the transistor 10. the transistor 13 comprises a single transistor, which is substantially identical to the transistor 10. The transistor 12 comprises a compound transistor, which is substantially identical to the compound transistor 11. The gains of the transistors 11 and 12 are greater than the gains of the transistors 10 and 13 for m greater than one. The gates of the transistors 10 and 12 are connected together to receive the input voltage Vin+ whereas the gates of the transistors 11 and 13 are connected together to receive the input voltage Vin−. The transconductance stage thus receives a differential input voltage (Vin+)−(Vin−) and converts this to a differential output current (Iout+)−(Iout−) with a transconductance gₘ.

The differential output current is supplied to the transistors 16 to 19, which, with load resistors 20 and 21, form the current switching stage. The sources of the transistors 16 and 17 are connected to the drains of the transistors 10 and 12 whereas the sources of the transistors 18 and 19 are connected to the drains of the transistors 11 and 13. The gates of the transistors 16 and 18 are connected together to receive the local oscillator voltage Vlo+ whereas the gates of the transistors 17 and 19 are connected together to receive the local oscillator voltage Vlo−. The drains of the transistors 16 and 19 are connected to a first terminal of the resistor 20 and to an output terminal for supplying the output voltage Vout+ whereas the drains of the transistors 17 and 18 are connected to a first terminal of the resistor 21 and to an output terminal for supplying the output voltage Vout−. The second terminals of the resistors 20 and 21 are connected to a supply line Vdd.

In an alternative embodiment for use with lower supply voltages, the multiplier has a “folded” topology. Such an arrangement has current mirrors whose inputs receive the output currents Iout+ and Iout− from the transconductance stage and whose outputs supply a switching stage comprising transistors of conductivity type opposite that of the transistors shown in FIG. 3. The current mirrors may be of the type whose output currents are equal to the input currents. Alternatively, the current mirrors may provide output currents which are a multiple of the input currents so as to increase the gain, and hence the transconductance of the stage.

The differential output current (Iout+)−(Iout−) of the transconductance stage is switched to the final multiplier output by means of a differential radio frequency carrier in the form of a differential voltage (Vlo+)−(Vlo−) supplied by a local oscillator (not shown).

Given a fixed current and (transistor) device size, the value of and non-linearity in the transconductance gₘ varies with device multiplier m as illustrated in FIG. 4B. Given modern deep sub-micron CMOS technologies, where device modelling is largely empirical, it is not possible to arrive at definitive analytical expressions for these curves as is the case in bipolar technologies. Nevertheless the trend is the same irrespective of CMOS device operating regime (weak, moderate or strong inversion): as with all linearisation techniques requiring no extra power consumption, transconductance decreases as linearisation improves.

For comparison, FIG. 4A illustrates the results achieved with traditional linearisation techniques (resistive degeneration/voltage overdrive) to yield the same transconductance.

The unique gₘ linearity of the multi-tanh approach leads to the concept of harmonic signature, where the third-order distortion produced exhibits a unique characteristic against input signal amplitude for any given bias (I, m, W or L in FIG. 3) conditions.

When applied to constant envelope baseband input signals (i.e. of fixed amplitude), for any given m, a third-harmonic distortion minimum is evident as a consequence of harmonic signature.

The multiplier shown in FIG. 3 maybe used in any application where the input voltage to the transconductance stage is a sine wave of substantially constant and known peak-to-peak amplitude. A typical example of an application is in a mixer or modulator for performing frequency changing. For example, the multiplier shown in FIG. 3 may be used as each of the mixers 4 and 5 in the transmitter modulator shown in FIG. 1.

Assuming a ±100 mVpk input sinusoidal differential input voltage from the DAC 3 in FIG. 1, HD3 versus gₘ can be plotted for Traditional (30) and CMOS (31) multi-tanh linearization techniques. As shown in FIG. 5, for a gₘ of 12 uS in this example, it is clear the HD3 developed by the multi-tanh technique is far lower than that of traditional techniques.

Thus, using this method, multiplier m (or other bias conditions such as I, W or L in FIG. 3) can be optimally chosen to yield a transconductance of 12 uS, so that, for the given ±100 mVpk input differential voltage swing, the third harmonic distortion in the Gilbert mixer is minimised. When such a linearized Gilbert mixer is applied in the IQ modulator shown in FIG. 1, the transmit spurious emission levels at the offset F_{3LSB} frequency are nulled, at least in theory.

In the offset pairs of transistors, it is required to provide different gains in the different limbs. Although this may be achieved by providing transistors of different performances by varying the widths and lengths of the channels or by varying the tail currents provided by the current sources, there are advantages in achieving the different gains by making at least one of the transistors in each offset pair a compound transistor comprising a plurality of transistors connected in parallel. In particular, because of the nature of the manufacturing processes, it is difficult or impossible to make transistors or current sources with accurately definable or predictable performances. However, it is relatively easy to make components of substantially identical structures and performances. Thus, as shown in FIG. 3, the “higher gain” compound transistors in each offset pair comprise a plurality of transistors, each of which is identical to the lower gain transistor. The relative gains may therefore be selected by choosing the multiplier m in order to achieve the third harmonic distortion null illustrated by the characteristic 31 in FIG. 5.

A technique for designing a multiplier of this type involves simulating the harmonic distortion performance for a plurality of values of m for a given input signal level (Vin+)−(Vin−). The value of the m which gives the lowest third harmonic distortion is then selected and the multiplier may be manufactured using this value as the number of transistors in the each of the compound transistors 11 and 12. Given the discrete nature of the selection of the number m of transistors, it is generally sufficient to choose a value for m which provides operation at or adjacent the minimum in the third harmonic distortion characteristic so as to achieve a degree of third harmonic distortion attenuation or suppression which is sufficient for the particular application of the multiplier.

This method is not optimal for general applications of the multi-tanh principle and, in particular, where the input signals have a varying amplitude (as in circuits used in receiver mixers or filters without very powerful automatic gain control). In such cases, the transconductance at which HD3 is a minimum varies with input differential voltage amplitude.

Thus, embodiments of the present invention can achieve, in addition to linearization of transconductance for no additional power consumption, minimal third-harmonic distortion for systems having a constant amplitude input signal. In practice, when applied to wireless transmitters operating with constant envelope modulation schemes, output modulated third-harmonic distortion induced RF spurious levels may be effectively nulled or attenuated sufficiently to be of no consequence.

1. A multiplier for multiplying a first alternating signal of substantially constant amplitude by a second signal, comprising a transconductance stage for converting said first signal to a differential current and a current steering stage for steering said differential current in accordance with said second signal, said transconductance stage comprising a plurality of offset pairs of transistors, said offset pairs having inputs connected in parallel and outputs connected in parallel, said transistors of each said offset pair having relative gains such that a minimum in third harmonic distortion occurs substantially at said amplitude of said first signal.

2. A multiplier as claimed in claim 1, in which said transistors are metal oxide silicon transistors.

3. A multiplier as claimed in claim 2, in which said transistors are complementary metal oxide silicon transistors.

4. A multiplier as claimed in claim 1, in which said first signal is in a sine wave of substantially constant peak-to-peak amplitude.

5. A multiplier as claimed in claim 1, in which said second signal is an alternating signal.

6. A multiplier as claimed in claim 5, in which said second signal is of substantially constant amplitude.

7. A multiple as claimed in claim 1, in which said offset pairs are substantially identical to each other.

8. A multiplier as claimed in claim 1, in which said offset pairs have substantially identical tail currents.

9. A multiplier as claimed in claim 1, in which each of said offset pairs comprises a first transistor and a compound transistor arranged as a differential pair, said compound transistor comprising m second transistors connected in parallel with each other, where m is selected to provide said minimum in said third harmonic distortion and each of said second transistors is substantially identical to said first transistor.

10. A multiplier as claimed in claim 1, in which said plurality of offset pairs comprises two said offset pairs, each of which comprises a transistor of higher gain having an output and a transistor of lower gain having an output, said output of said transistor of higher gain of each of said pairs being connected to said output of said transistor of lower gain of an other of said pairs.

11. A multiplier as claimed in claim 1, in which said current steering stage comprises a current switching stage.

12. A multiplier as claimed in claim 11, in which said current switching stage comprises two pairs of cross-coupled transistors.

13. A multiplier as claimed in claim 1, in which at least one of said first and second signals is a radio frequency signal.

14. A mixer for a receiver, comprising a multiplier for multiplying a first alternating signal of substantially constant amplitude by a second signal, said multiplier comprising a transconductance stage for converting said first signal to a differential current and a current steering stage for steering said differential current in accordance with said second signal, said transconductance stage comprising a plurality of offset pairs of transistors, said offset pairs having inputs connected in parallel and outputs connected in parallel, said transistors of each said offset pair having relative gains such that a minimum in third harmonic distortion occurs substantially at said amplitude of said first signal.

15. A receiver comprising a mixer which comprises a multiplier for multiplying a first alternating signal of substantially constant amplitude by a second signal, said multiplier comprising a transconductance stage for converting said first signal to a differential current and a current steering stage for steering said differential current in accordance with said second signal, said transconductance stage comprising a plurality of offset pairs of transistors, said offset pairs having inputs connected in parallel and outputs connected in parallel, said transistors of each said offset pair having relative gains such that a minimum in third harmonic distortion occurs substantially at said amplitude of said first signal.

16. A modulator comprising a first multiplier for multiplying a first alternating signal of substantially constant amplitude by a second signal, said multiplier comprising a transconductance stage for converting said first signal to a differential current and a current steering stage for steering said differential current in accordance with said second signal, said transconductance stage comprising a plurality of offset pairs of transistors, said offset pairs having inputs connected in parallel and outputs connected in parallel, said transistors of each said offset pair having relative gains such that a minimum in third harmonic distortion occurs substantially at said amplitude of said first signal.

17. A modulator as claimed in claim 16, in which said first signal is an information carrying signal and said second signal is a carrier wave.

18. A modulator as claimed in claim 17, in which said first signal is one of a frequency and phase modulated signal.

19. A modulator as claimed in claim 16, comprising a second multiplier for multiplying a third alternating signal of substantially constant amplitude by a fourth signal, said second multiplier comprising a further transconductance stage for converting said third signal to a further differential current and a further current steering stage for steering said further differential current in accordance with said fourth signal, said further transconductance stage comprising a plurality of further offset pairs of transistors, said further offset pairs having inputs connected in parallel and outputs connected in parallel, said transistors of each said further offset pair having relative gains such that a minimum in said third harmonic distortion occurs substantially at said amplitude of said third signal, said second multiplier cooperating with said first multiplier to form a single sideband suppressed carrier modulator.

20. A transmitter comprising a modulator which comprises a multiplier for multiplying a first alternating signal of substantially constant amplitude by a second signal, said multiplier comprising a transconductance stage for converting said first signal to a differential current and a current steering stage for steering said differential current in accordance with said second signal, said transconductance stage comprising a plurality of offset pairs of transistors, said offset pairs having inputs connected in parallel and outputs connected in parallel, said transistors of each said offset pair having relative gains such that a minimum in third harmonic distortion occurs substantially at said amplitude of said first signal.

21. A method of designing a multiplier for multiplying a first alternating signal of substantially constant amplitude by a second signal, said multiplier comprising a transconductance stage for converting said first signal to a differential current and a current steering stage for steering said differential current in accordance with said second signal, said transconductance stage comprising a plurality of offset pairs of transistors, said offset pairs having inputs connected in parallel and outputs connected in parallel, said transistors of each said offset pair having relative gains such that a minimum in third harmonic distortion occurs substantially at said amplitude of said first signal, said method comprising specifying said constant amplitude, simulating an operation of said multiplier for a plurality of values of said relative gains to determine said third harmonic distortion, and selecting a relative gain value corresponding to a third harmonic distortion value at or adjacent a minimum in said third harmonic distortion characteristic.

22. A method of making a multiplier, comprising: designing a multiplier for multiplying a first alternating signal of substantially constant amplitude by a second signal, said multiplier comprising a transconductance stage for converting said first signal to a differential current and a current steering stage for steering said differential current in accordance with said second signal, said transconductance stage comprising a plurality of offset pairs of transistors, said offset pairs having inputs connected in parallel and outputs connected in parallel, said transistors of each said offset pair having relative gains such that a minimum in third harmonic distortion occurs substantially at said amplitude of said first signal, said method comprising: specifying said constant amplitude, simulating an operation of said multiplier for a plurality of values of said relative gains to determine said third harmonic distortion, and selecting a relative gain value corresponding to a third harmonic distortion value at or adjacent a minimum in said third harmonic distortion characteristic to provide a design for said multiplier; and manufacturing said multiplier in accordance with said design.
